(19) United States
(12) Patent Application Publication
(10) Pub. No.: US 2026/0230435 A1
(43) Pub. Date: Aug. 6, 2026

(54) HANDLING MESSAGES RELATED TO AN APPLICATION FUNCTION SESSION BOUND TO A PROTOCOL DATA UNIT SESSION

(71) Applicant: Telefonaktiebolaget LM Ericsson (publ), Stockholm (SE)

(72) Inventors: Aleksejs UDALCOVS, Stockholm (SE); György MIKLÓS, Pilisborosjenö (HU); Fuencisla GARCIA AZORERO, Madrid (ES); Marilet DE ANDRADE JARDIM, Kista (SE); Shabnam SULTANA, Montreal, Québec (CA)

(73) Assignee: Telefonaktiebolaget LM Ericsson (publ), Stockholm (SE)

(21) Appl. No.: 19/147,068

(22) PCT Filed: Dec. 12, 2023
(86) PCT No.: PCT/EP2023/085403

§ 371 Date: Jul. 10, 2025

Related U.S. Application Data
(60) Provisional application No. 63/438,986, filed on Jan. 13, 2023.

(51) Int. Cl. H04L 47/28; H04L 47/24

(52) U.S. Cl. CPC H04L 47/28; H04L 47/24

(57) ABSTRACT

There is provided a method performed by a policy control function (PCF). The method comprises receiving, from either a network exposure function (NEF) or a time sensitive communication and time synchronization function (TSCTSF), a first request related to an application function (AF) session bound to a protocol data unit (PDU) session. The method further comprises after receiving the first request related to the AF session bound to the PDU session, determining whether the PDU session is potentially for time sensitive communication (TSC). The method further comprises, based on determining whether the PDU session is potentially for TSC, determining whether to accept or reject the first request; and transmitting towards the NEF or the TSCTSF a first response indicating whether the first request is accepted or not.

### TECHNICAL FIELD

This disclosure relates to handling messages related to an application function (AF) session bound to a protocol data unit (PDU) session.

### BACKGROUND

The 3rd Generation Partnership Project (3GPP) Technical Specification 23.502, version 17.7.0 (TS 23.502) discloses a process of setting up an application function, AF, session with required quality of service (QoS).

The process begins by an AF sending to a network exposure function (NEF) a create request to reserve service resources for an AF session. After receiving the create request, the NEF determines whether to direct the signaling to a policy control function (PCF) directly or via a time sensitive communication and time synchronization function (TSCTSF). The determination may be made based on a set of individual QoS parameters or requested alternative QoS parameter set(s) received from the AF.

After the AF session is established with the required QoS, the AF may want to update the AF session with updated QoS. In such case, the AF may send to an update request to update service resources for the AF session. After receiving the update request, the NEF determines again whether to direct the signaling to the PCF directly or via the TSCTSF. The determination may be made based on a set of individual QoS parameters or requested alternative QoS parameter set(s) received from the AF.

In order to request a specific QoS, the create request and/or the update request may include either:
(1) QoS reference+(optional) traffic characteristics (i.e., flow direction, burst arrival time at a user equipment (UE) (uplink), or a user plane function (UPF) (downlink), a periodicity, a time domain, a survival Time), or
(2) Individual QoS parameters (i.e., Requested 5G system (5GS) delay (optional), requested priority (optional), requested guaranteed bitrate, requested maximum bitrate, maximum burst size)+(optional) traffic characteristics (i.e., flow direction, burst arrival time at UE (uplink) or an UPF (downlink), a periodicity, a time domain, survival time).

3GPP TS 23.503, version 17.6.0 (TS 23.503) suggests that the create request and the update request associated with the same AF session should have the same type of QoS information. For example, in case the create request includes a QoS reference, the AF cannot include individual QoS parameters instead of a QoS reference. In other words, the AF cannot replace the previously provided QoS in the create request with individual QoS parameters in the update request. In another example, in case the create request includes individual QoS parameter(s), the AF cannot include a QoS reference instead of individual QoS parameter(s).

As briefly discussed above, the signaling from the NEF to the PCF may be performed directly between the NEF and the PCF, or may be performed indirectly via the TSCTSF.

Such indirective signaling (i.e., the signaling via the TSCTSF) may be required in case of the presence of certain QoS parameters in the AF request (e.g., the aforementioned create request, the aforementioned update request, etc.). Examples of such QoS parameters include any of time sensitive communication assistance container (TSCAC) related parameters (i.e., a flow direction, burst arrival time at UE (uplink) or UPF (downlink), a periodicity, a time domain, survival time) describing traffic characteristics and may be provided regardless whether the create and update request contains a QoS reference or individual QoS parameters. Another example is when individual QoS parameters in the create or in the update request contain a requested 5GS delay (e.g., which may comprise a UE-device-side time sensitive networking (TSN) translator (UE-DS-TT) residence time). In other cases, the directive signaling may be performed between the NEF and the PCF (without going through the TSCTSF).

### SUMMARY

Certain challenges presently exist. For example, as explained above, in case the type of the QoS information included the update request is different from the type of the QoS information included in the create request, the NEF shall reject the update request because the update request requires a signaling path (e.g., an indirect signaling path between the NEF and the PCF via the TSCTSF) that is different from the signaling path (e.g., a direct signaling path between the NEF and the PCF) required for the create request.

For example, if the update request includes a requested 5GS delay and TSCAC related information (which requires a signaling via a TSCTSF) while the create request does not, the NEF may determine that the update request requires a signaling path that is different from the signaling path for the create request, and thus reject the update request even though the update request was legit.

If the update request is rejected, the AF would need to send another create request (either directly or via the TSCTSF), thereby resulting in excessive signaling and service interruption. Thus, there is a need to determine the signaling path between the NEF and the PCF during a creation of an AF session.

In order to solve this problem, in one aspect of the embodiments of this disclosure, there is provided a performed by a policy control function (PCF). The method comprises receiving from either a network exposure function NEF or a time sensitive communication and time synchronization function (TSCTSF) a first request related to an application function (AF) session bound to a protocol data unit (PDU) session. The method further comprises, after receiving the first request related to the AF session bound to the PDU session, determining whether the PDU session is potentially for time sensitive communication (TSC). The method further comprises, based on determining whether the PDU session is potentially for TSC, determining whether to accept or reject the first request. The method further comprises transmitting towards the NEF or the TSCTSF a first response indicating whether the first request is accepted or not.

In another aspect, there is provided a method performed by a network exposure function (NEF). The method comprises transmitting towards a policy control function, PCF, a first request related to an application function, AF, session bound to a protocol data unit, PDU, session. The method further comprises, after transmitting the first request, receiving from the PCF a first response indicating that the first request is rejected, wherein the first response indicates that a time sensitive communication and time synchronization function, TSCTSF, is required for the AF session bound to the PDU session.

In another aspect, there is provided a method performed by a time sensitive communication and time synchronization function, TSCTSF. The method comprises transmitting towards a policy control function, PCF, a first request related to an application function, AF, session bound to a protocol data unit, PDU, session. The method further comprises, after transmitting the first request, receiving (s504) from the PCF a first response indicating that the first request is rejected, wherein the first response indicates that a TSCTSF is not required for the AF session bound to the PDU session.

In another aspect, there is provided a computer program comprising instructions which when executed by processing circuitry (602) cause the processing circuitry to perform the method of any one of the embodiments described above.

In another aspect, there is provided a carrier containing the computer program of the embodiment above, wherein the carrier is one of an electronic signal, an optical signal, a radio signal, and a computer readable storage medium.

In another aspect, there is provided a policy control function, PCF. The PCF is configured to: receive from either a network exposure function, NEF, or a time sensitive communication and time synchronization function, TSCTSF, a first request related to an application function, AF, session bound to a protocol data unit, PDU, session; and after receiving the first request related to the AF session bound to the PDU session, determine whether the PDU session is potentially for time sensitive communication, TSC. The PCF is configured to based on determining whether the PDU session is potentially for TSC, determine whether to accept or reject the first request; and transmit towards the NEF or the TSCTSF a first response indicating whether the first request is accepted or not.

In another aspect, there is provided a network exposure function, NEF. The NEF is configured to: transmit towards a policy control function, PCF, a first request related to an application function, AF, session bound to a protocol data unit, PDU, session; and after transmitting the first request, receive from the PCF a first response indicating that the first request is rejected, wherein the first response indicates that a time sensitive communication and time synchronization function, TSCTSF, is required for the AF session bound to the PDU session.

In another aspect, there is provided a time sensitive communication and time synchronization function, TSCTSF. The TSCTSF is configured to: transmit towards a policy control function, PCF, a first request related to an application function, AF, session bound to a protocol data unit, PDU, session; and after transmitting the first request, receive from the PCF a first response indicating that the first request is rejected, wherein the first response indicates that a TSCTSF is not required for the AF session bound to the PDU session.

In another aspect, there is provided an apparatus comprising a processing circuitry; and a memory, said memory containing instructions executable by said processing circuitry, whereby the apparatus is operative to perform the method of any one of the embodiments described above.

Some embodiments of this disclosure allow determining the signaling path for a request during the creation of an AF session, thereby minimizing the probability that a legit request update from the AF is rejected.

### BRIEF DESCRIPTION OF THE DRAWINGS

The accompanying drawings, which are incorporated herein and form part of the specification, illustrate various embodiments.

FIG. 1 shows a portion of a system according to some embodiments.

FIG. 2A shows a process according to some embodiments.

FIG. 2B shows a process according to some embodiments.

FIG. 3 shows a process according to some embodiments.

FIG. 4 shows a process according to some embodiments.

FIG. 5 shows a process according to some embodiments.

FIG. 6 shows an apparatus according to some embodiments.

### DETAILED DESCRIPTION

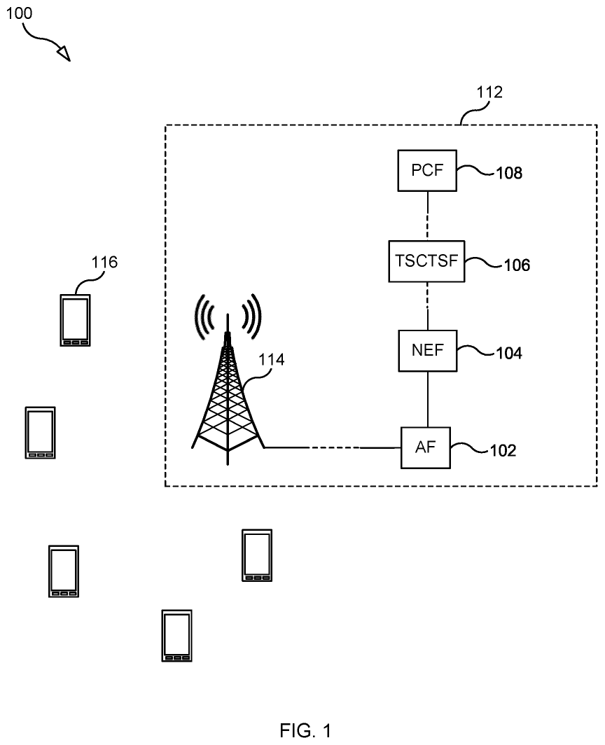

FIG. 1 shows a part of a system 100 according to some embodiments. In system 100, user equipments (UEs) 116 (e.g., a mobile phone, a computer, a watch, a tablet, a vehicle, an Internet of Thing (IoT) device, etc.) are connected to a base station 114 via a wireless network provided by base station 114. Base station 114 is a part of a 3GPP network system 112 which comprises AF 102, NEF 104, TSCTSF 106, and PCF 108. Note that a number of each of the entities (102, 104, 106, 108, 114, 116, etc.) shown in FIG. 1 is provided for simple explanation purpose only, and does not limit the embodiments of this disclosure in any way. Also note that FIG. 1 shows only a part of 3GPP network system 112 (meaning that 3GPP network system 112 may include additional entities). A network function/node can be implemented either as a network element on a dedicated hardware, as a software instance running on a dedicated hardware, or as a virtualised function instantiated on an appropriate platform, e.g., on a cloud infrastructure.

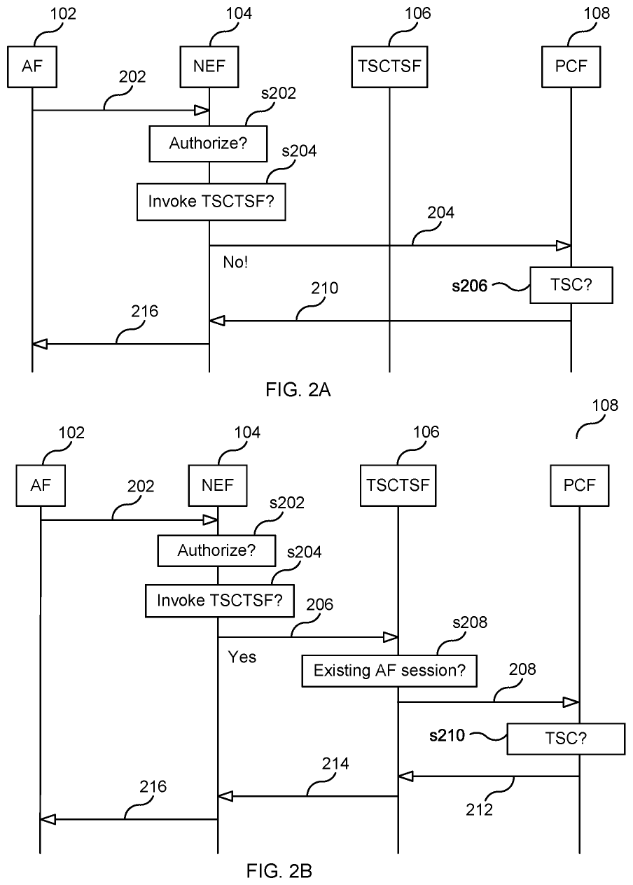

AF 102 is a control plane function within 5G core network. AF 102 may be configured to create an AF session for providing application services (e.g., a video streaming service) to UEs 116. FIGS. 2A and 2B show a process 200 for creating an AF session according to some embodiments.

Process 200 may begin with AF 102 transmitting to NEF 104 an AF request 202. In some embodiments, AF request 202 may correspond to a request to provide a specific QoS (e.g., the minimum video resolution) for an AF session (e.g., a video streaming service) for a UE 116. One example of such request is Nnef_AFsessionWithQoS Create request.

In case AF request 202 is a request to provide a specific QoS, upon receiving AF request 202, NEF 104 may perform step s202. Step s202 comprises determining whether to authorize AF request 202 or not. If NEF 104 determines not to authorize AF request 202, NEF 104 may send to AF 102 AF response 216 indicating that AF request 202 has been rejected. One example of AF response 216 is Nnef_AFsessionWithQoS Create response.

On the other hand, in case NEF 104 determines to authorize AF request 202, in step s204, NEF 104 may further determine whether to invoke TSCTSF 106 in signaling PCF 108 or whether to directly signal PCF 108 (i.e., whether to transmit/receive message(s) to/from PCF 108 without passing through TSCTSF 106 or whether to transmit/receive message(s) to/from PCF 108 via TSCTSF 106). This determination may be made based on the presence of a particular QoS reference or particular QoS individual parameter(s) in AF request 202. Additionally or alternatively, the determination may be based on an AF identifier identifying a particular AF session or AF provided parameters that describe the traffic characteristics.

As shown in FIG. 2A, in case NEF 104 determines to signal PCF 108 directly without using TSCTSF 106, NEF 104 may send to PCF 108 a NEF request 204. In some embodiments, NEF request 204 is a request for creating one or more policies as required by AF 102 for a PDU session to which the AF session is bound. In one example, NEF request 204 is a Npcf_PolicyAuthorization_Create request.

Upon receiving NEF request 204, in step s206, PCF 108 may determine whether the PDU session bound to the AF session for which NEF request 204 is made is for time sensitive communication (TSC) (i.e., whether a TSCTSF is potentially required in a signaling path between NEF 104 and PCF 108). One example of determining that the PDU session is for TSC is determining that the PDU session is potentially impacted by precision time protocol (PTP) time synchronization service. Determining whether the PDU session for which NEF request 204 is made is for TSC may be made based on any one or more of 5GS Bridge information, a data network name (DNN), network slice selection assistance information (S-NSSAI), an application identifier (ID) identifying an application; a group ID identifying a UE group, and/or a local configuration. For example, mere presence of 5GS Bridge information may indicate that the PDU session may be used for TSC. Alternatively or additionally, a DNN identifying a certain data network, S-NSSAI identifying a certain network slice, and/or an application ID identifying a certain application may indicate that the PDU session is potentially for TSC. More detailed information about these parameters is provided in clause 5.2.27.3 of 3GPP TS 23.502, which is hereby incorporated by reference.

Note that PCF 108 knows whether NEF request 204 is originated by NEF 104 or TSCTSF 106. For example, NEF 104 and TSCTSF 106 may be configured to user-agent HTTP header in the requests they send to PCF 108. In another example, each of the requests may include a different information element or parameter identifying the sender of the request. Thus, in case PCF 108 determines that the PDU session bound to the AF session is potentially for TSC, PCF 108 may reject NEF request 204 because the request is originated by NEF 104, which indicates that there is no TSCTSF for this signalling between NEF 104 and PCF 108.

Accordingly, PCF 108 may send to NEF 104 NEF response 210 indicating that NEF request 204 is rejected. One example of NEF response 210 is a Npcf_PolicyAuthorization_Create response. In some embodiments, NEF response 210 may indicate that a TSCTSF is required for the AF session bound to the PDU session. Such information may be very useful to NEF 104 because NEF 104 now knows that a TSCTSF is required for the AF session bound to the PDU session, and thus, when NEF 104 retries to send the NEF request, NEF 104 may send the request via TSCSTF 106 (instead of sending the request directly to PCF 108).

On the other hand, in case PCF 108 determines that the PDU session bound to the AF session is not potentially for TSC, PCF 108 may accept NEF request 204 because the request is originated by NEF 104, which indicates that there is no TSCTSF for this signaling between NEF 104 and PCF 108. In this case, NEF response 210 may indicate that NEF request 204 is accepted. One example of NEF response 210 is a Npcf_PolicyAuthorization_Create response.

Upon receiving NEF response 210, NEF 104 may send to AF 102 AF response 216 indicating that AF request 202 has been accepted. One example of AF response 216 is Nnef_AFsessionWithQoS Create response.

Referring back to step s204, as shown in FIG. 2B, in case NEF 104 determines to invoke a TSCTSF in signaling PCF 108, instead of sending NEF request 204 to PCF 108, NEF 104 may send to TSCTSF 106 an NEF request 206. In some embodiments, NEF request 206 is a request to provide a specific QoS for an AF session. In one example, NEF request 206 is Ntsctsf_QoSandSCAssistance_Create request.

In case NEF request 206 is a request to provide a specific QoS for an AF session, upon receiving NEF request 206, TSCTSF 106 may determine in step s208 whether it has an AF session with a PCF for a given UE address. If so, TSCTSF 106 may send towards PCF 108 a TSCTSF request 208. In some embodiments, TSCTSF request 208 is a request to provide a specific QoS for an AF session. One example of TSCTSF request 208 is Npcf_PolicyAuthorization_Update request.

On the other hand, in case TSCTSF 106 determines that it currently does not have an AF session with a PCF for the given UE address, TSCTSF 106 may discover PCF 108, and send TSCTSF request 208. Here, examples of TSCTSF request 208 are Npcf_PolicyAuthorization_Create request or Npcf_PolicyAuthorization_Subscribe request.

Upon receiving TSCTSF request 208, in step s210, PCF 108 may determine whether the PDU session bound to the AF session for which TSCTSF (Create or Subscribe) request 208 is made is for time sensitive communication (TSC) (i.e., whether a TSCTSF is potentially required in a signaling path between NEF 104 and PCF 108). One example of determining that the PDU session is potentially for TSC is determining that the PDU session is potentially impacted by precision time protocol (PTP) time synchronization service. Such determination may be made based on any one or more of 5GS Bridge information, a data network name (DNN), network slice selection assistance information (S-NSSAI), an application identifier (ID) identifying an application; a group ID identifying a UE group, and/or a local configuration.

Note that, in some embodiments, if the PDU session is potentially for TSC (i.e., if a TSCTSF needs to be in the signaling path between NEF 104 and PCF 108), PCF 108 may send to TSCTSF 106 a message including the 5GS Bridge information. In such embodiments, PCF 108 may check, in step s210, whether PCF 108 has sent the 5GS Bridge information to TSCTSF 106 or not.

PCF 108 knows whether TSCTSF request 208 is originated by NEF 104 or TSCTSF 106 (e.g., by analyzing the user-agent HTTP header of NEF request 204). Thus, in case PCF 108 determines that the PDU session is not potentially for TSC, PCF 108 may reject TSCTSF request 208 because the request is originated by TSCTSF 106, which indicates that there is a TSCTSF for this signaling between NEF 104 and PCF 108. In this case, PCF 108 may send to TSCTSF 106 TSCTSF response 212 indicating that TSCTSF request 208 is rejected. In some embodiments, TSCTSF response 212 may indicate that a TSCTSF is not required for the PDU session. Examples of TSCTSF response 212 are Npcf_PolicyAuthorization_Create response and Npcf_PolicyAuthorization_Subscribe response.

On the other hand, in case PCF 108 determines that the PDU session bound to the AF session is potentially for TSC, PCF 108 may accept TSCTSF request 208 because the request is originated by TSCTSF 106, which indicates that there is a TSCTSF for this signaling between NEF 104 and PCF 108. In this case, PCF 108 may send to TSCTSF 106 TSCTSF response 212 indicating that TSCTSF request 208 is accepted.

Upon receiving TSCTSF response 212, TSCTSF 106 may send to NEF 104 a NEF response 214. Examples of NEF response 214 are Ntsctsf_QoSandTSCAssistance_Create response. According to some embodiment, in case NEF response 214 is a rejection message rejecting NEF request 206, NEF response 214 may indicate why NEF request 206 is rejected. For example, NEF response 214 may indicate that a TSCTSF is not required in the signaling path between NEF 104 and PCF 108 for the PDU session. This information may be very useful to NEF 104 since when NEF 104 retries to send the request, NEF 104 can try sending the request directly to PCF 108 (instead of sending via TSCTSF 106).

Upon receiving NEF response 214, NEF 104 may transmit towards AF 102 AF response 214 indicating whether AF request 202 is accepted or not.

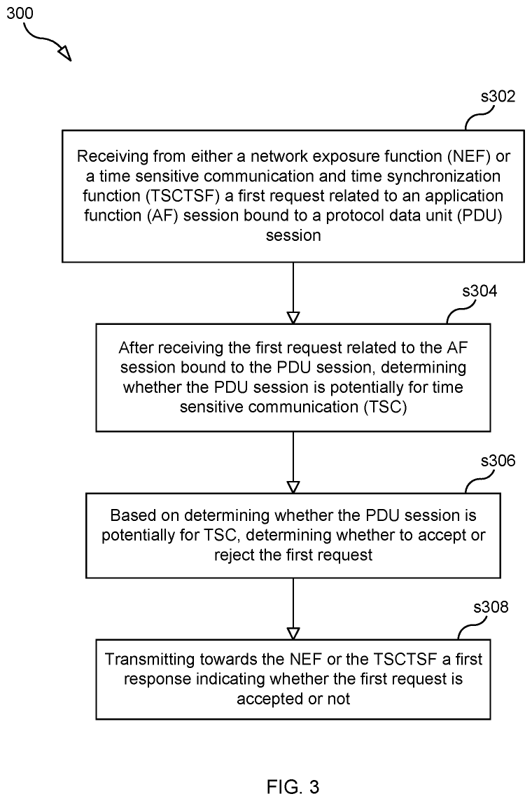

FIG. 3 shows a process 300 performed by PCF 108 according to some embodiments. Process 300 may begin with step s302. Step s302 comprises receiving from either NEF 104 or TSCTSF a first request related to an AF session bound to a PDU session. Step s304 comprises, after receiving the first request related to the AF session bound to the PDU session, determining whether the PDU session is potentially for time sensitive communication (TSC). Step s306 comprises, based on determining whether the PDU session is potentially for TSC, determining whether to accept or reject the first request. Step s308 comprises transmitting towards the NEF or the TSCTSF a first response indicating whether the first request is accepted or not.

In some embodiments, process 300 comprises determining whether the first request was originated by the NEF or the TSCTSF, wherein whether to accept or reject the first request is determined further based on determining whether the first request was originated by the NEF or the TSCTSF.

In some embodiments, the first request is a request to create one or more policies for the PDU session bound to the AF session, or a request to subscribe to reporting of one or more events at the PCF.

In some embodiments, the first request is any one of: Npcf_PolicyAuthorization_Create request; or Npcf_PolicyAuthorization_Subscribe request.

In some embodiments, whether the PDU session is potentially for TSC is determined based on any one or more of: 5GS Bridge information; a certain data network name, DNN; a certain network slice selection assistance information, S-NSSAI; a certain application identifier, ID, identifying a certain application; a certain group ID identifying a user equipment, UE, group; or a certain local configuration related to a certain set of one or more rules and/or policies.

In some embodiments, the process 300 comprises identifying that the first request was originated by the NEF, determining whether the PDU session is potentially for TSC comprises determining that the TSCTSF is the network function, NF, type required for the request, and the first response is a rejection message rejecting the first request.

In some embodiments, the rejection message indicates that a TSCTSF is required for the AF session bound to the PDU session.

In some embodiments, the process 300 comprises identifying that the first request was transmitted by the TSCTSF and determining that the PDU session bound to the AF session is not potentially for the TSC, the first response is a rejection message rejecting the first request, and the rejection message indicates that a TSCTSF is not required for the AF session bound to the PDU session.

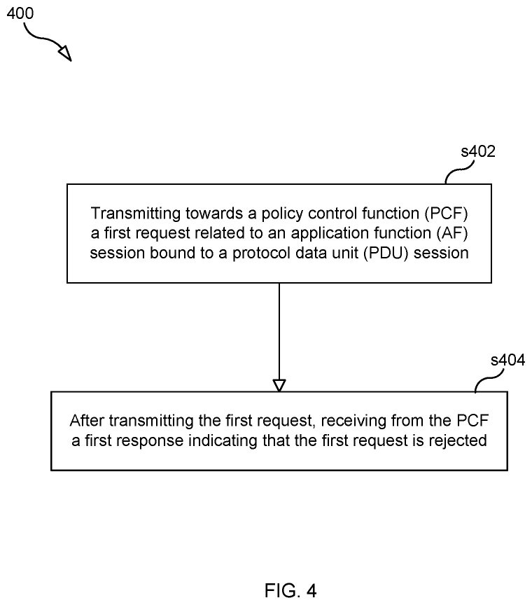

FIG. 4 shows a process 400 performed by NEF 104 according to some embodiments. Process 400 may begin with step s402. Step s402 comprises transmitting towards PCF a first request related to an AF session bound to a PDU, session. Step s404 comprises, after transmitting the first request, receiving from the PCF a first response indicating that the first request is rejected, wherein the first response indicates that a TSCTSF is required for the AF session bound to the PDU session.

In some embodiments, the first request is a request to create one or more policies for the PDU session bound to the AF session, or a request to subscribe to reporting of one or more events at the PCF.

In some embodiments, the first request is any one of: Npcf_PolicyAuthorization_Create request; or Npcf_PolicyAuthorization_Subscribe request.

In some embodiments, whether a TSCTSF is required for the AF session bound to the PDU session is determined by the PCF based on any one or more of: 5GS Bridge information; a certain data network name, DNN; a certain network slice selection assistance information, S-NSSAI; a certain application identifiers, ID, identifying a certain application; a certain group ID identifying a user equipment, UE, group; or a certain local configuration related to a certain set of one or more rules and/or policies.

In some embodiments, process 400 comprises after receiving the first response, transmitting towards a first TSCTSF a second request for requesting to provide a specific quality of service, QoS, for a certain application function, AF, session; and after transmitting the second request, receiving from the first TSCTSF a second response accepting the second request.

In some embodiments, the second request is Ntsctsf_QoSandTSCAssistance_Create request, and the second response is Ntsctsf_QoSandTSCAssistance_Create response.

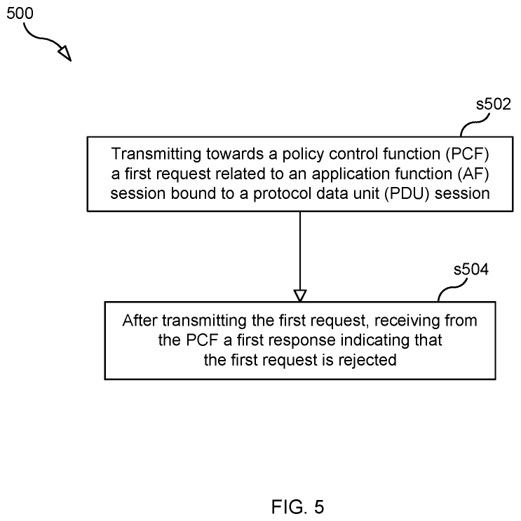

FIG. 5 shows a process 500 performed by TSCTSF 106 according to some embodiments. Process 500 may begin with step s502. Step s502 comprises transmitting towards PCF 108 a first request related to an AF session bound to a PDU, session. Step s504 comprises, after transmitting the first request, receiving from the PCF a first response indicating that the first request is rejected, wherein the first response indicates that a TSCTSF is not required for the AF session bound to the PDU session.

In some embodiments, the first request is a request to create one or more policies for the PDU session or a request to subscribe to reporting of one or more events at the PCF.

In some embodiments, the first request is any one of: Npcf_PolicyAuthorization_Create request; or Npcf_PolicyAuthorization_Subscribe request.

In some embodiments, whether a TSCTSF is potentially required for the AF session bound to the PDU session is determined by the PCF based on any one or more of: 5GS Bridge information; a certain data network name, DNN; a certain network slice selection assistance information, S-NSSAI; a certain application identifiers, ID, identifying a certain application; a certain group ID identifying a user equipment, UE, group; or a certain local configuration related to a certain set of one or more rules and/or policies.

In some embodiments, process 500 comprises receiving from a network exposure function, NEF a second request for requesting to provide a specific quality of service, QoS, for a certain application function, AF, session; after receiving the second request, transmitting towards the NEF a second response rejecting the second request, wherein the second response indicates that a TSCTSF is not required for the AF session bound to the PDU session.

In some embodiments, the second request is Ntsctsf_QoSandTSCAssistance_Create request, and the second response is Ntsctsf_QoSandTSCAssistance_Create response.

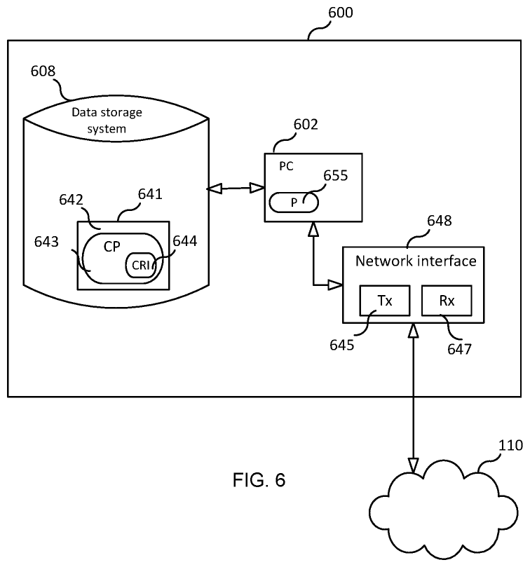

FIG. 6 is a block diagram of an apparatus 600, according to some embodiments, for implementing any one or a combination of AF 102, NEF 104, TSCTSF 106 and PCF 108. As shown in FIG. 6, apparatus 600 may comprise: processing circuitry (PC) 602, which may include one or more processors (P) 655 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 600 may be a distributed computing apparatus); a network interface 648 comprising a transmitter (Tx) 645 and a receiver (Rx) 647 for enabling apparatus 600 to transmit data to and receive data from other nodes connected to a network 110 (e.g., an Internet Protocol (IP) network) to which network interface 648 is connected (directly or indirectly) (e.g., network interface 648 may be wirelessly connected to the network 110, in which case network interface 648 is connected to an antenna arrangement); and a local storage unit (a.k.a., “data storage system”) 608, which may include one or more non-volatile storage devices and/or one or more volatile storage devices. In embodiments where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes apparatus 600 to perform steps described herein (e.g., steps described herein with reference to the flow charts). In other embodiments, apparatus 600 may be configured to perform steps described herein without the need for code. That is, for example, PC 602 may consist merely of one or more ASICs. Hence, the features of the embodiments described herein may be implemented in hardware and/or software.

Abbreviations

| Abbreviation | Explanation |
|---|---|
| AF | Application Function |
| CN | Core Network |
| DNN | Data Network Name |
| DS-TT | Device Side Translator |
| NF | Network Function |
| NEF | Network Exposure Function |
| PCF | Policy Control Function |
| PDB | Packet Delay Budget |
| QoS | Quality of Service |
| SMF | Session Management Function |
| S-NSSAI | Single Network Slice Selection |
| | Assistance Information |
| TSCAC | Time Sensitive Communication |
| | Assistance Container |
| TSCTSF | Time Sensitive Communication |
| | and Time Synchronization Function |
| UE | User Equipment |
| UPF | User Plane Function |

### Summary of Embodiments

Some embodiments described above can be summarized as follows:

The PCF could determine whether a Create request is not being routed via the TSCTSF, and thus, respond to the
NEF with a special error cause, that indicates the signaling path for the whole AF session has to go via the TSCTSF.
According to TS 23.501, 6.2.29 TSCTSF, the TSCTSF supports the detection of the 5GS Bridge information, and
the determination of the requested PDB (other QoS parameters, as the priority level may also be determined by the
TSCTSF).
So, if the TSCTSF needs to be in the signaling path, the PCF needs to notify to the TSCTSF about the 5GS Bridge
Information.
And to enable the PCF notifies the TSCTSF, the PCF needs to know beforehand (based on DNN/S-NSSAI and
GPSI and/or SUPI/Internal Group Id or local configuration) whether a PDU session is for TSC communications.
Taking above into account, if the PCF receives an Npcf_PolicyAuthorization_Create request that binds to a PDU
session for TSC communications, but this request is not originated by the TSCTSF, then the PCF could reject the
request and indicate that the TSCTSF is required for the TSC PDU session; similarly, if the PCF receives an
Npcf_PolicyAuthorization_Creation request that is originated by the TSCTSF, but the PDU session is not for TSC
communications, the PCF could reject the request and indicate that the TSCTSF is not required for the non-TSC
PDU session.
For the stage 3 specs, the PCF can check which NF is sending the request based on the User-Agent HTTP header
included by the NF service consumer (see TS 29.500, 5.2.2.2). Then, based on the received value in the User-Agent
header: (Impacts to TS 29.514) If User-Agent: TSCTSF, and the PDU session is not a TSC PDU session, the PCF
returns a 403 Forbidden with error cause (e.g.) NON_TSC_PDU_SESSION, to the TSCTSF.
The TSCTSF forwards this error to the NEF (impact in TS 29.565). The NEF then does not select a TSCTSF, but
the PCF, in the subsequent attempt to create an AF session (impact in TS 29.522).
(Impacts to TS 29.514) If User-Agent: NEF (or AF), and the PDU session is a TSC PDU session, the PCF returns a
403 Forbidden with error cause (e.g.) TSC_PDU_SESSION to the NEF (or AF).
(Impacts to TS 29.522) The NEF then includes the TSCTSF in the signaling path for the subsequent attempt to
create an AF session.

A1. A method (300) performed by a policy control function, PCF (108), the method comprising:
receiving (s302) from either a network exposure function, NEF (104), or a time sensitive communication and time synchronization function, TSCTSF (106), a first request related to an application function, AF, session bound to a protocol data unit, PDU, session;
after receiving the first request related to the AF session bound to the PDU session, determining (s304) whether the PDU session is potentially for time sensitive communication, TSC;
based on determining whether the PDU session is potentially for TSC, determining (s306) whether to accept or reject the first request; and
transmitting (s308) towards the NEF or the TSCTSF a first response indicating whether the first request is accepted or not.

A1a. The method of embodiment A1, comprising:
determining whether the first request was transmitted by the NEF or the TSCTSF, wherein
whether to accept or reject the first request is determined further based on determining whether the first request was transmitted by the NEF or the TSCTSF.

A2. The method of embodiment A1 or Ala, wherein the first request is a request to create one or more policies for the PDU session bound to the AF session, or a request to subscribe to reporting of one or more events at the PCF.

A3. The method of embodiment A2, wherein the first request is any one of:
Npcf_PolicyAuthorization_Create request; or
Npcf_PolicyAuthorization_Subscribe request.

A4. The method of any one of embodiments A1-A3, wherein whether the PDU session is potentially for TSC is determined based on any one or more of:
5GS Bridge information;
a certain data network name, DNN;
a certain network slice selection assistance information, S-NSSAI;
a certain application identifier, ID, identifying a certain application;
a certain group ID identifying a user equipment, UE, group; or
a certain local configuration related to a certain set of one or more rules and/or policies.

A5. The method of any one of embodiments A1a-A4, wherein
the method comprises identifying that the first request was transmitted by the NEF and determining that the PDU session bound to the AF session is potentially for the TSC,
the first response is a rejection message rejecting the first request, and
the rejection message indicates that a TSCTSF is required for the AF session bound to the PDU session.

A6. The method of any one of embodiments A1a-A4, wherein
the method comprises identifying that the first request was transmitted by the TSCTSF and determining that the PDU session bound to the AF session is not potentially for the TSC,
the first response is a rejection message rejecting the first request, and
the rejection message indicates that a TSCTSF is not required for the AF session bound to the PDU session.

B1. A method (400) performed by a network exposure function, NEF (104), the method comprising:
transmitting (s402) towards a policy control function, PCF (108), a first request related to an application function, AF, session bound to a protocol data unit, PDU, session; and
after transmitting the first request, receiving (s404) from the PCF a first response indicating that the first request is rejected, wherein
the first response indicates that a time sensitive communication and time synchronization function, TSCTSF, is required for the AF session bound to the PDU session.

B2. The method of embodiment B1, wherein the first request is a request to create one or more policies for the PDU session bound to the AF session, or a request to subscribe to reporting of one or more events at the PCF.

B3. The method of embodiment B2, wherein the first request is any one of:
Npcf_PolicyAuthorization_Create request; or
Npcf_PolicyAuthorization_Subscribe request.

B4. The method of any one of embodiments B1-B3, wherein whether a TSCTSF is required for the AF session bound to the PDU session is determined by the PCF based on any one or more of: 5GS Bridge information;
a certain data network name, DNN;
a certain network slice selection assistance information, S-NSSAI;
a certain application identifiers, ID, identifying a certain application;
a certain group ID identifying a user equipment, UE, group; or
a certain local configuration related to a certain set of one or more rules and/or policies.

B5. The method of any one of embodiments B1-B4, comprising:
after receiving the first response, transmitting towards a first TSCTSF a second request for requesting to provide a specific quality of service, QoS, for a certain application function, AF, session; and
after transmitting the second request, receiving from the first TSCTSF a second response accepting the second request.

B6. The method of embodiment B5, wherein
the second request is Ntsctsf_QoSandTSCAssistance_Create request, and
the second response is Ntsctsf_QoSandTSCAssistance_Create response.

C1. A method (500) performed by a time sensitive communication and time synchronization function, TSCTSF (106), the method comprising:
transmitting (s502) towards a policy control function, PCF (108), a first request related to an application function, AF, session bound to a protocol data unit, PDU, session; and
after transmitting the first request, receiving (s504) from the PCF a first response indicating that the first request is rejected, wherein
the first response indicates that a TSCTSF is not required for the AF session bound to the PDU session.

C2. The method of embodiment C1, wherein the first request is a request to create one or more policies for the PDU session or a request to subscribe to reporting of one or more events at the PCF.

C3. The method of embodiment C2, wherein the first request is any one of:
Npcf_PolicyAuthorization_Create request; or
Npcf_PolicyAuthorization_Subscribe request.

C4. The method of any one of embodiments C1-C3, wherein whether a TSCTSF is potentially required for the AF session bound to the PDU session is determined by the PCF based on any one or more of:
5GS Bridge information;
a certain data network name, DNN;
a certain network slice selection assistance information, S-NSSAI;
a certain application identifiers, ID, identifying a certain application;
a certain group ID identifying a user equipment, UE, group; or
a certain local configuration related to a certain set of one or more rules and/or policies.

C5. The method of any one of embodiments C1-C4, comprising:
receiving from a network exposure function, NEF a second request for requesting to provide a specific quality of service, QoS, for a certain application function, AF, session;
after receiving the second request, transmitting towards the NEF a second response rejecting the second request, wherein
the second response indicates that a TSCTSF is not required for the AF session bound to the PDU session.

C6. The method of embodiment C5, wherein the second request is Ntsctsf_QoSandTSCAssistance_Create request, and the second response is Ntsctsf_QoSandTSCAssistance_Create response.

D1. A computer program (600) comprising instructions (644) which when executed by processing circuitry (602) cause the processing circuitry to perform the method of any one of embodiments A1-C6.

D2. A carrier containing the computer program of embodiment D1, wherein the carrier is one of an electronic signal, an optical signal, a radio signal, and a computer readable storage medium.

E1. A policy control function, PCF (108), the PCF being configured to:
receive (s302) from either a network exposure function, NEF (104), or a time sensitive communication and time synchronization function, TSCTSF (106), a first request related to an application function, AF, session bound to a protocol data unit, PDU, session;
after receiving the first request related to the AF session bound to the PDU session, determine (s304) whether the PDU session is potentially for time sensitive communication, TSC;
based on determining whether the PDU session is potentially for TSC, determine (s308) whether to accept or reject the first request; and
transmit (s310) towards the NEF or the TSCTSF a first response indicating whether the first request is accepted or not.

E2. The PCF of embodiment E1, wherein the PCF is configured to perform the method of any one of embodiments A2-A6.

F1. A network exposure function, NEF (104), the NEF being configured to:
transmit (s402) towards a policy control function, PCF (108), a first request related to an application function, AF, session bound to a protocol data unit, PDU, session; and
after transmitting the first request, receive (s404) from the PCF a first response indicating that the first request is rejected, wherein
the first response indicates that a time sensitive communication and time synchronization function, TSCTSF, is required for the AF session bound to the PDU session.

F2. The NEF of embodiment F1, wherein the NEF is configured to perform the method of any one of embodiments B2-B6.

G1. A time sensitive communication and time synchronization function, TSCTSF (106), the TSCTSF being configured to:
transmit (s502) towards a policy control function, PCF (108), a first request related to an application function, AF, session bound to a protocol data unit, PDU, session; and
after transmitting the first request, receive (s504) from the PCF a first response indicating that the first request is rejected, wherein
the first response indicates that a TSCTSF is not required for the AF session bound to the PDU session.

G2. The TSCTSF of embodiment G1, wherein the TSCTSF is configured to perform the method of any one of embodiments C2-C6.

H1. An apparatus (600) comprising:
a processing circuitry (602); and
a memory (641), said memory containing instructions executable by said processing circuitry, whereby the apparatus is operative to perform the method of any one of embodiments A1-C6.

### CONCLUSION

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-29. (canceled)

30. A method performed by a first network function (NF), the method comprising:
receiving from a second NF a service request to create an Application Function (AF) session context,
after receiving the service request, determining whether a time sensitive communication and time synchronization function (TSCTSF) is a NF type required for the service request;
determining whether to accept or reject the service request when determining that the TSCTSF is the NF type required for the service request; and
transmitting towards the second NF a first response to reject the service request and the first response indicates that a signalling path for the service request is invalid when determining rejecting the service request and the TSCTSF is the NF type required for the service request.

31. The method of claim 30, wherein
the method comprises identifying that the service request was transmitted by the TSCTSF and determining that the TSCTSF is not the NF type required for the request,
the first response is a rejection message rejecting the service request, and
the rejection message indicates that a TSCTSF is not required for service request.

32. The method of claim 30, wherein
the first network function is a policy control function (PCF),
the method further comprises determining whether the service request was originated by a network exposure function (NEF) or the TSCTSF, and
the PCF determines whether to accept or reject the service request based on whether the service request was determined to be originated by the NEF or the TSCTSF.

33. The method of claim 30, wherein
the service request is a request to create one or more policies for a PDU session bound to the AF session, or
the service request is a request to subscribe to reporting of one or more events at the first NF.

34. The method of claim 33, wherein the service request is any one of:
Npcf_PolicyAuthorization_Create request; or
Npcf_PolicyAuthorization_Subscribe request.

35. The method of claim 30, wherein whether the TSCTSF is the NF type required for the service request is determined based on:
5GS Bridge information;
a certain data network name, DNN;
a certain network slice selection assistance information, S-NSSAI;
a certain application identifier, ID, identifying a certain application;
a certain group ID identifying a user equipment, UE, group; and/or
a certain local configuration related to a certain set of one or more rules and/or policies.

36. The method of claim 30, wherein
the method further comprises identifying that the service request was originated by the NEF,
determining whether a PDU session is potentially for TSC comprises determining that the TSCTSF is the network function, NF, type required for the service request, and
the first response is a rejection message rejecting the service request.

37. A method performed by a second network function (NF), the method comprising:
transmitting towards a first NF a service request to create an AF session context; and
after transmitting the service request, receiving from the first NF a first response indicating that the service request is rejected, wherein
the first response indicates that a time sensitive communication and time synchronization function (TSCTSF) is required for the service request.

38. The method of claim 37, wherein
whether a TSCTSF is required for the AF session for the service request is determined by the first NF based on:
5GS Bridge information;
a certain data network name, DNN;
a certain network slice selection assistance information, S-NSSAI;
a certain application identifiers, ID, identifying a certain application;
a certain group ID identifying a user equipment, UE, group; and/or
a certain local configuration related to a certain set of one or more rules and/or policies.

39. The method of claim 37, wherein
the service request is a request to create one or more policies for a PDU session bound to the AF session, or
the service request is a request to subscribe to reporting of one or more events at the first NF.

40. The method of claim 39, wherein
the first NF is a policy control function, and
the service request is a Npcf_PolicyAuthorization_Create request or a Npcf_PolicyAuthorization_Subscribe request.

41. The method of claim 37, comprising:
after receiving the first response, transmitting towards a first TSCTSF a second request for requesting to provide a specific quality of service (QoS) for a certain AF session; and
after transmitting the second request, receiving from the first TSCTSF a second response accepting the second request.

42. The method of claim 41, wherein
the second request is Ntsctsf_QoSandTSCAssistance_Create request, and
the second response is Ntsctsf_QoSandTSCAssistance_Create response.

43. A first network function (NF), the first NF comprising:
memory; and
processing circuitry, wherein the first NF is configured to perform a method comprising:
receiving from a second NF a service request to create an Application Function (AF) session context,
after receiving the service request, determining whether a time sensitive communication and time synchronization function (TSCTSF) is a NF type required for the service request;
determining whether to accept or reject the service request when determining that the TSCTSF is the NF type required for the service request; and
transmitting towards the second NF a first response to reject the service request and the first response indicates that a signalling path for the service request is invalid when determining rejecting the service request and the TSCTSF is the NF type required for the service request.

44. The first NF of claim 43, wherein
the method further comprises identifying that the service request was transmitted by the TSCTSF and determining that the TSCTSF is not the NF type required for the request,
the first response is a rejection message rejecting the service request, and
the rejection message indicates that a TSCTSF is not required for service request.

45. The first NF of claim 43, wherein
the first network function is a policy control function (PCF),
the method further comprises determining whether the service request was originated by a network exposure function (NEF) or the TSCTSF, and
the PCF determines whether to accept or reject the service request based on whether the service request was determined to be originated by the NEF or the TSCTSF.

46. A second network function (NF), the second NF comprising:
memory; and
processing circuitry, wherein the first NF is configured to perform a method comprising:
transmitting towards a first NF a service request to create an AF session context; and
after transmitting the service request, receiving from the first NF a first response indicating that the service request is rejected, wherein
the first response indicates that a time sensitive communication and time synchronization function (TSCTSF) is required for the service request.

47. The second NF of claim 46, wherein
the service request is a request to create one or more policies for a PDU session bound to the AF session, or
the service request is a request to subscribe to reporting of one or more events at the first NF.
